(19) United States
(12) Patent Application Publication
(10) Pub. No.: US 2003/0122500 A1
(43) Pub. Date: Jul. 3, 2003

(54) Electronic ballast of fluorescent lamp for reducing current of electrodes after lamp turns on

(75) Inventors: Jim H. Liang, Taipei (TW); Min-Tsai Su, Taipei (TW); Kuo-Chien Huang, Taipei (TW)

Correspondence Address: BACON & THOMAS, PLLC, 625 SLATERS LANE, FOURTH FLOOR, ALEXANDRIA, VA, 22314

(73) Assignee: Skynet Electronic Co., Ltd., Taipei (TW)

(21) Appl. No.: 10/102,642

(22) Filed: Mar. 22, 2002

(30) Foreign Application Priority Data
Dec. 31, 2001 (TW) 090133208

(51) Int. Cl. H01J 7/24

(52) U.S. Cl. 315/224; 315/112

(57) ABSTRACT

The present invention relates to an electronic ballast of fluorescent lamp, which comprises an resonant element being parallelly connected to a lamp at a distal side from a power source for participating in starting the lamp or preheating electrodes thereof to achieve the purposes of providing an appropriate current for preheating electrodes in starting and substantially reducing or eliminating the current of electrodes after the lamp being turned on, so that an undesirable power consumption in electrodes is avoided.

### FIELD OF THE INVENTION

The present invention relates to ballast of fluorescent lamp and more particularly to an improved electronic ballast of fluorescent lamp for reducing current of electrodes after the lamp turns on, and enabling the current passed through both electrodes and lamp to be adjusted and designed independently in either starting or a table state.

### BACKGROUND OF THE INVENTION

As understood that a fluorescent substance in fluorescent lamp gives off light when mercury vapor in the lamp is acted upon by a stream of electrons from the cathode. Conventionally, a ballast is in series with the lamp for reducing a large current across electrodes at both ends of the lamp. Ballast comprises an inductor in the form of coil wherein a magnetic field is produced therearound when a current passes through the inductor. Also, a varying current can produce a varying magnetic field. In response, flux of inductor is changed. Then a counter electromotive force is induced for eliminating the change of flux. As a result, a significant change of current of electrodes is avoided, thereby stabilizing current of electrodes.

Another function of ballast is to initiate high voltage across electrodes for turning on a fluorescent lamp. As known that in the activation of fluorescent lamp current must flow through electrodes for preheating. Then a stream of electrons is produced in fluorescent lamp due to bombardment of electrons in current onto electrodes. Sufficient electrons are produced when electrodes are preheated sufficiently. In response, electrons are leaving electrodes. The leaving electrons act on mercury vapor in the lamp after have been accelerated by high voltage across electrodes. In turn, more and more electrons are ionized prior to acting on mercury vapor in the lamp. As a result, a fluorescent light is given off from the lamp as the vapor has become conductive. It is also known that a normal operating voltage of fluorescent lamp is not capable of causing mercury vapor to give off light by discharging. In view of above, ballast is critical to the activation of fluorescent lamp.

A number of conventional techniques have been implemented for starting a fluorescent lamp as detailed below.

1) Low Frequency Ballast: It has a metal contact and a capacitor having a small capacitance value as a starting circuit which is parallel connected to lamp. Metal contact is deformed to open the circuit due to high temperature when current passes the contact. In response, a high voltage is produced across both ends of lamp for staring the lamp. Such low frequency ballast is disadvantageous because ends of lamp tend to become black after a short period of time of use due to higher voltage. As a result, a useful life of lamp is shortened. Moreover, a transformer formed of low frequency silicone metal is provided in the ballast. Such transformer is bulky and low in efficiency.

2) Series Resonant Electronic Ballast: As shown in FIG. 1, current flowed through electrodes 12 of the series resonant electronic ballast is current of resonant capacitor Cₚ₁. Further, two methods are implemented in a circuit of the series resonant electronic ballast depending on current control of electrodes as follows:

(A) Fixed Frequency Control: Two switches Q₁₁ and Q₁₂ under a fixed frequency control of driver circuit are used for controlling current in preheating fluorescent lamp. Also, the amount of current depends on resonant capacity of capacitor Cₚ₁ which in turn is in proportional to current passed through lamp 11 (i.e., ionized electrons produced by vapor in lamp). Hence, it is impossible of independently adjusting current passed through both electrodes and lamp. Thus, an optimum current passed through electrodes or lamp is not obtainable.

(B) Varied Frequency Control: Switches Q₁₁ and Q₁₂ under a varied frequency control of driver circuit are used for controlling operating frequencies of electrodes preheating and in a stable state, thereby determining current for preheating electrodes and current passed through lamp. It is disadvantageous because circuitry thereof is complicated. Typically, an IC (Integrated Circuit) is required. Hence, its cost is high. Moreover, current passed through electrodes is not eliminated after the lamp turns on, i.e., current still passes through electrodes. As a result, a useful life of lamp is shortened.

3) PTC (Positive Temperature Coefficient) Resistor Preheating Electronic Ballast: As shown in FIG. 2, switches Q₂₁ and Q₂₂ are under the control of driver circuit. When fluorescent lamp is not turned on, resistance value of resistor R_{PTC} is low. Hence, voltage across two ends of lamp is not high enough to start the lamp. When temperature of resistor R_{PTC} rises, resistance value also rises. In response, voltage across two ends of lamp is risen until it is high enough to start the lamp. Current passed through resistor R_{PTC} also passes through electrodes, i.e., a preheating effect is carried out. However, after the lamp turns on, current of resonant capacitor Cₚ₂ still passes electrodes. In other words, it still has the drawback of incapable of independently adjusting current passed through both electrodes and lamp. Referring to FIGS. 3 and 4, each illustrates a modified version of a circuit of electronic ballast shown in FIG. 2. In both FIG. 3 and FIG. 4, capacitors C_{P11} and C_{P12} are easier to select with respect to pressure and capacity. However, the drawback of incapable of independently adjusting current passed through both electrodes and lamp still exists.

4) Other Preheating Techniques: As shown in FIGS. 5 and 6, in the electronic ballast voltage and current of electrodes are detected for estimating temperature of electrodes in the process of preheating. As shown in FIG. 7, in the electronic ballast amount of preheating current is determined based on charging time of capacitor C_{dc} having a large capacity. However, resonant capacitor of each of ballast shown in FIGS. 5 to 7 is located on a distal side from power source. After lamp turns on, current passed through electrodes is not eliminated, resulting in an undesirable power consumption in electrodes. In FIG. 8, a circuit diagram of a electronic ballast available from. Tridonic Company is shown. For preheating electrodes, two additional windings M_{1b} and M_{1c} are provided in parallel connected to electrodes. It is disadvantageous because two switches, one transformer M₁ₐ and a capacitor are additionally required, resulting in a more complicated circuitry and higher cost.

Thus, it is desirable to provide an improved electronic ballast of fluorescent lamp capable of reducing current of electrodes after the lamp turns on in order to overcome the above drawbacks of prior art, i.e., current passed through electrodes is not eliminated after the lamp turns on; overheating of ends of lamp, shortened useful life of lamp, impossible of independently adjusting current passed through both electrodes and lamp, complicated circuitry, and higher cost.

### SUMMARY OF THE INVENTION

It is therefore an object of the present invention to provide an electronic ballast of fluorescent lamp for substantially reducing or eliminating current in preheating electrodes after the lamp turns on so that an undesirable power consumption in electrodes is avoided.

It is another object of the present invention to provide an electronic ballast of fluorescent lamp for independently controlling current during electrodes preheating process, current of electrodes in stable state, and current of lamp. Hence, it is possible of independently adjusting current passed through both electrodes and lamp, resulting in obtaining a high efficient electronic ballast.

It is still another object of the present invention to provide an electronic ballast of fluorescent lamp wherein an element participating in starting the lamp or preheating electrodes is parallel connected to lamp at a distal side from power source; and after the lamp turns on, resonant element is parallel connected to lamp at a proximate side from power source so that it is possible of independently adjusting current passed through both electrodes and lamp in either starting or a table state without increasing circuit elements and cost.

The above and other objects, features and advantages of the present invention will become apparent from the following detailed description taken with the accompanying drawings.

### BRIEF DESCRIPTION OF THE DRAWINGS

FIG. 1 is a circuit diagram of a conventional series resonant electronic ballast;

FIG. 2 is a circuit diagram of a conventional PTC resistor preheating electronic ballast;

FIG. 3 is a circuit diagram of the first modified conventional PTC resistor preheating electronic ballast of FIG. 2;

FIG. 4 is circuit diagram of the second modified conventional PTC resistor preheating electronic ballast of FIG. 2;

FIG. 5 is a circuit diagram of a conventional electronic ballast wherein voltage and current of electrodes are detected for estimating temperature of electrodes in the process of preheating;

FIG. 6 is a circuit diagram of another conventional electronic ballast wherein voltage and current of electrodes are detected for estimating temperature of electrodes in the process of preheating;

FIG. 7 is a circuit diagram of a conventional electronic ballast wherein the preheating current is determined based on charging time of capacitor C_{dc} having a large capacity;

FIG. 8 is a circuit diagram of a conventional electronic ballast wherein for preheating, two additional windings are provided in parallel to electrodes;

FIG. 9 is a circuit diagram of a preferred embodiment of electronic ballast of fluorescent lamp according to the invention;

FIG. 10 is a circuit diagram of another preferred embodiment of electronic ballast of fluorescent lamp according to the invention;

FIG. 11 is a waveform of series resonant current of the conventional PTC resistor preheating electronic ballast;

FIG. 12 is a waveform of current of electronic ballast according to the invention; and

FIG. 13 is a waveform of current of ballast circuit wherein another capacitor Cₚₛ is parallel connected to resistor R_{PTC} and lamp.

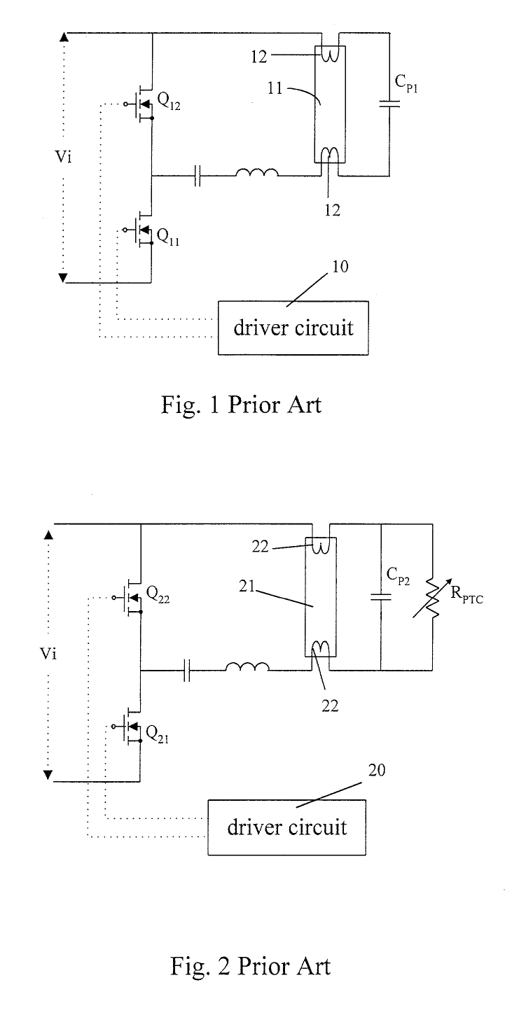

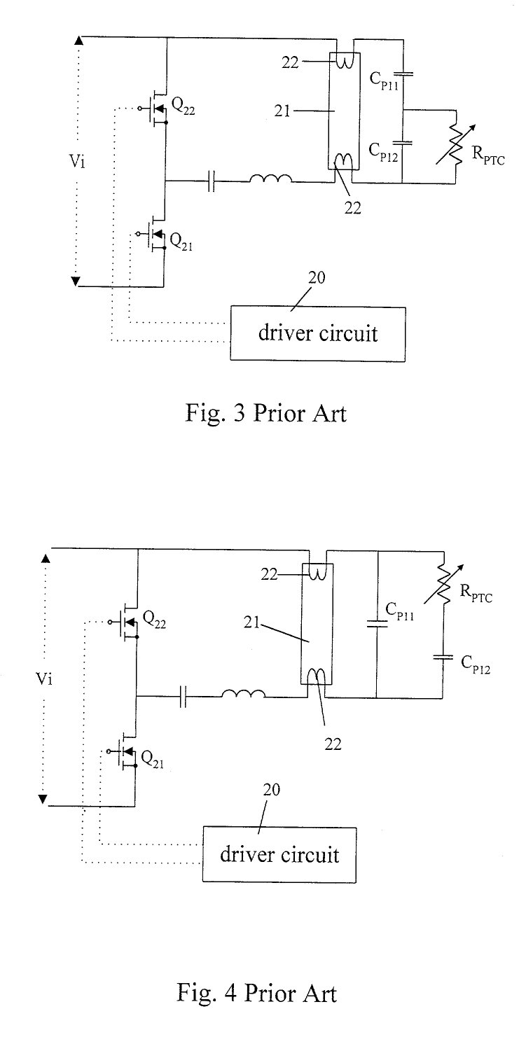

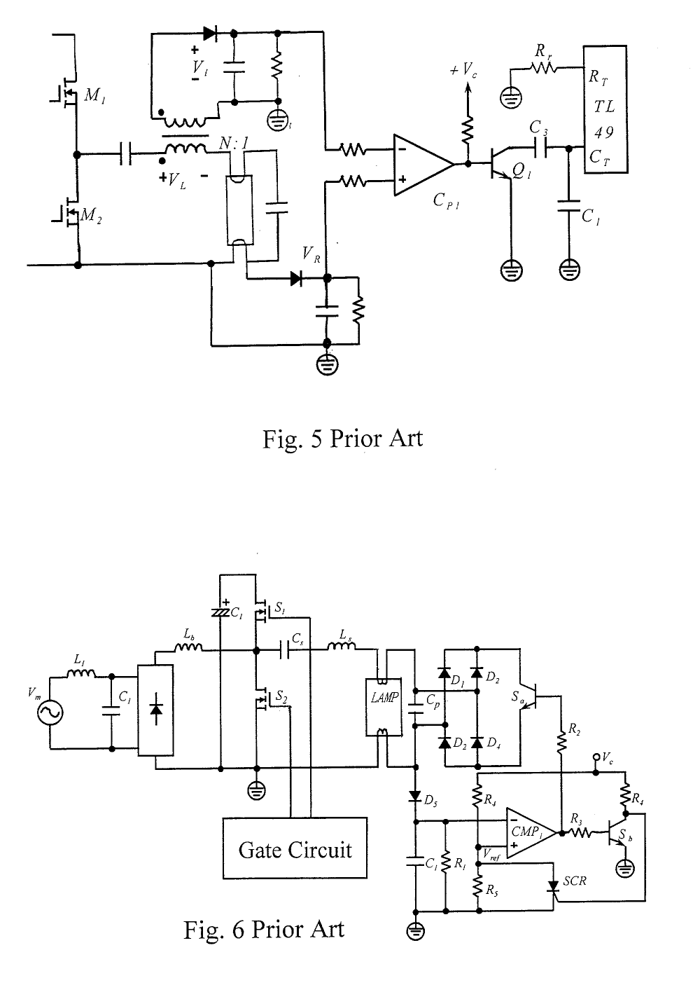

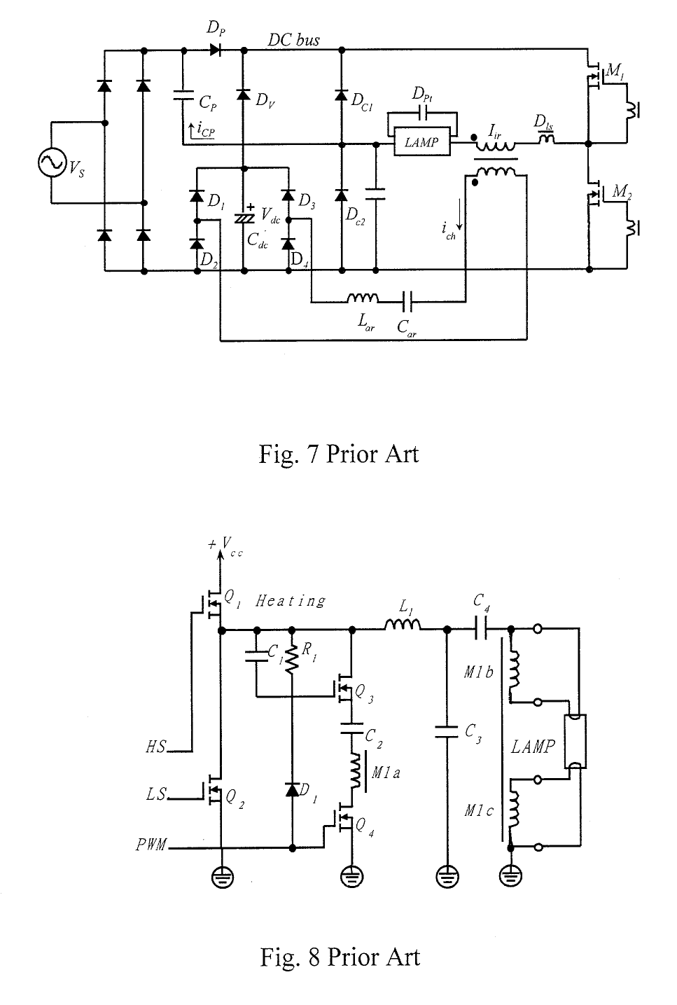

### DETAILED DESCRIPTION OF THE PREFERRED EMBODIMENTS

The present invention is directed to an electronic ballast of fluorescent lamp. In starting, an appropriate current is provided for preheating electrodes. After the lamp turns on, current of electrodes is substantially reduced or eliminated so that an undesirable power consumption in electrodes is avoided. Also, an element participating in starting the lamp or preheating electrodes is parallel connected to lamp at a distal side from power source. After the lamp turns on, resonant element is parallel connected to lamp at a proximate side from power source so that it is possible of achieving the purposes of providing an appropriate current for preheating electrodes in starting, and current of electrodes is substantially reduced or eliminated after the lamp turns on.

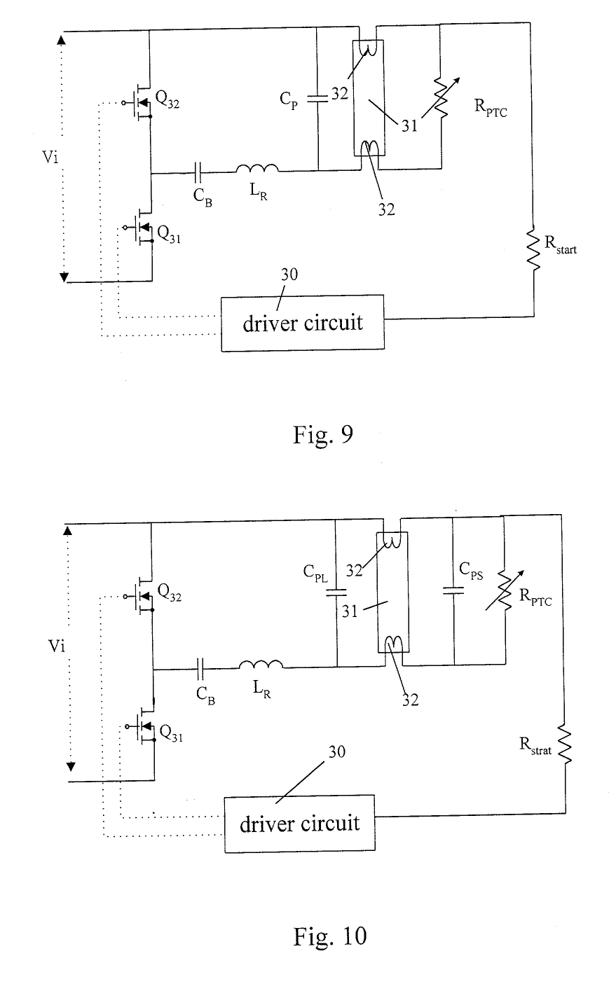

Referring to FIG. 9, there is shown a preferred embodiment of electronic ballast of fluorescent lamp constructed in accordance with the invention. The electronic ballast is implemented as a PTC resistor preheating electronic ballast. A PTC resistor R_{PTC} required for starting lamp and preheating electrodes is parallel connected to lamp 31 at a distal side from power source. After the lamp turns on, resonant element (i.e., capacitor) Cₚ is parallel connected to lamp at a proximate side from power source. As shown in FIG. 9, instead of a rectifier circuit required in electronic ballast Vi is labeled to represent a voltage source for operating the ballast circuit. It is appreciated by those skilled in the art that any technique for integrating rectifier circuit and electronic ballast of the invention is without departing from the scope and spirit of the invention.

In the embodiment, the electronic ballast comprises a driver circuit 30 for enabling or disabling two switches Q₃₁ and Q₃₂ so as to supply voltage of source Vi to the circuit and lamp 31. Switches Q₃₁ and Q₃₂ are in series with source Vi. Also, switch Q₃₂ is parallel connected to resonant capacitor Cₚ, lamp 31, and PTC resistor R_{PTC}. Further, a capacitor C_{B} and an inductor L_{R} are in series with resonant capacitor Cₚ and switch Q₃₂. Furthermore, a resistor Rₛₜₐᵣₜ is coupled between PTC resistor R_{PTC} and driver circuit 30. This is the connection of electronic ballast of the invention and lamp 31.

In starting the fluorescent lamp, switches Q₃₁ and Q₃₂ are under the control of driver circuit 30. When fluorescent lamp is not turned on, resistance value of resistor R_{PTC} is low. Hence, voltage across two ends of lamp is not high enough to start lamp. At this time, current passed through electrodes 32 to PTC resistor R_{PTC} is larger for achieving a fast preheating on electrodes 32. After the lamp turns on, resistance value of PTC resistor R_{PTC} rises as temperature thereof rises. In response, voltage across two ends of lamp 31 is risen until it is high enough to start lamp 31 (i.e., light is given off). Further, resistance value of PTC resistor R_{PTC} is very high. Hence, current passed through electrodes 32 to PTC resistor R_{PTC} is substantially reduced or eliminated. As a result, an undesirable power consumption in electrodes 32 is avoided.

After the lamp turns on the electrodes 31, current passed through electrodes 32 is substantially reduced or eliminated. At this time, PTC resistor R_{PTC} does not affect the current of lamp. Hence, in designing the circuitry PTC resistor R_{PTC} can be employed to independently adjust current passed through electrodes 32. Also, resonant capacitor Cₚ can be employed to independently adjust current passed through lamp 31. Thus, the purpose of independently adjusting current passed through both electrodes and lamp is achieved.

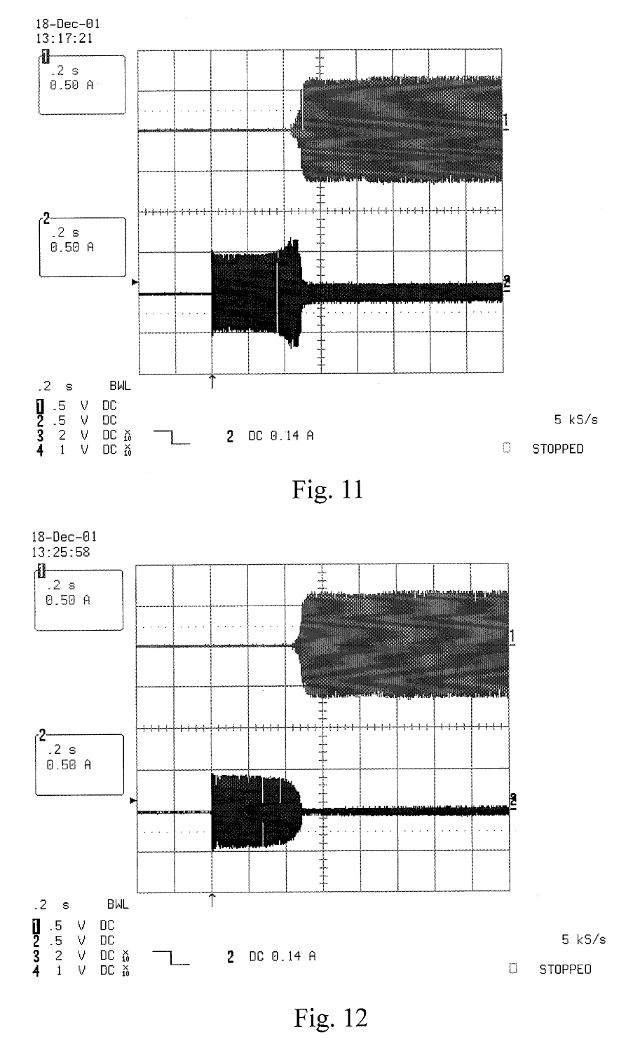

Referring to FIG. 11, there is shown a waveform of series resonant current of the conventional PTC resistor preheating electronic ballast. Referring to FIG. 12, there is shown a waveform of current of electronic ballast according to the invention. It is apparent from FIGS. 11 and 12 that after the lamp turns on, current of electrodes of electronic ballast according to the invention (see waveform of channel 2 in FIG. 12) is smaller than that of the conventional PTC resistor preheating electronic ballast (see waveform of channel 2 in FIG. 11) if lamp current is the same (see waveform of channel 1 in FIG. 11 or FIG. 12).

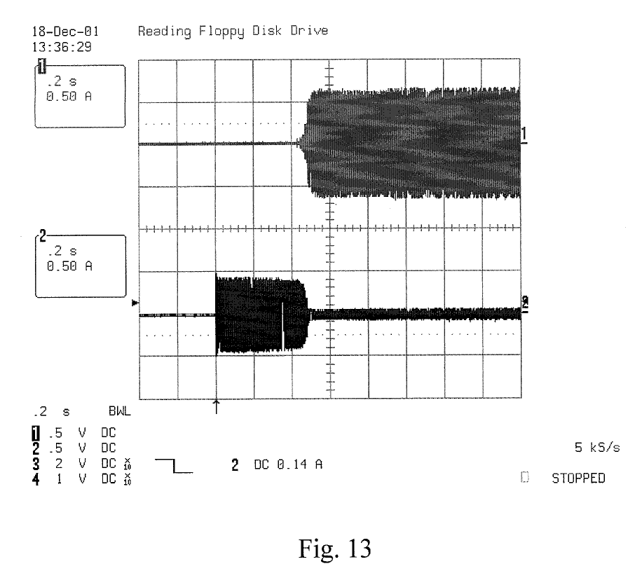

Referring to FIG. 10, there is shown another preferred embodiment of electronic ballast of fluorescent lamp constructed in accordance with the invention. This embodiment is substantially the same as above except the following. Another capacitor C_{PL} is parallel connected to PTC resistor R_{PTC} and lamp 31. After lamp 31 turns on, the capacitance value of capacitor C_{PL} may become larger or smaller than that of resonant capacitor C_{PS} depending on applications. That is, resonant capacitor C_{PL} is parallel connected to resonant capacitor C_{PS} on lamp 31 at a proximate side from power source. Hence, after lamp 31 turns on, current of electrodes can be adjusted to provide an appropriate current for preheating electrodes 32. As such, the electronic ballast of the invention is particularly suitable to operate in a cold environment. Referring to FIG. 13, this is the case that capacitor C_{PL} is parallel connected to resistor R_{PTC} and lamp 31 wherein a waveform of adjusted current of electrodes is shown (see waveform of channel 2 in FIG. 13) when lamp 31 turns on if lamp current is the same (see waveform of channel 1 in FIG. 11 or FIG. 12).

In brief, the invention is implemented as a PTC resistor preheating electronic ballast. An element participating in starting the lamp or preheating electrodes is parallel connected to lamp at a distal side from power source. After the lamp turns on, resonant element is parallel connected to lamp at a proximate side from power source so that it is possible of independently adjusting current passed through both electrodes and lamp in either starting or a table state without increasing circuit elements and cost. Moreover, after the lamp turns on current in preheating electrodes is substantially reduced or eliminated so that an undesirable power consumption in electrodes is avoided.

While the invention has been described by means of specific embodiments, numerous modifications and variations could be made thereto by those skilled in the art without departing from the scope and spirit of the invention set forth in the claims.

What is claimed is:

1. An electronic ballast of fluorescent lamp, the electronic ballast comprising:
a temperature sensing element for starting the lamp and preheating the electrodes, the temperature sensing element parallel connected to the lamp at a distal side from a power source; and
a resonant element required after the lamp turns on, the resonant element parallel connected to the lamp at a proximate side from the power source;
wherein the electronic ballast is operative to provide a predetermined current to electrodes for preheating, and to substantially reduce or eliminate the current of the electrodes after the lamp being turned on.

2. The electronic ballast of claim 1, further comprising a first capacitor parallel connected to the temperature sensing element and the lamp so that after the lamp turns on, the current of the electrodes is adjustable to provide the predetermined current to the electrodes for preheating.

3. The electronic ballast of claim 2, further comprising:
a driver circuit;
two switches coupled to the driver circuit respectively wherein the switches are controlled by the driver circuit to enable or disable a power supply from the power source to the electronic ballast and the lamp; the switches are in series with the power source; and one of the switches is parallel connected to the resonant element, the lamp, and the temperature sensing element;
a second capacitor;
an inductor in series with the second capacitor and the resonant element and parallel connected to one of the switches; and
a resistor coupled between the temperature sensing element and the driver circuit.

4. The electronic ballast of claim 3, wherein the temperature sensing element is a positive temperature coefficient resistor.

5. The electronic ballast of claim 3, wherein the resonant element is a resonant capacitor.

6. The electronic ballast of claim 3, wherein the power source is a voltage source of a rectifier circuit.
